(19) United States
(12) Patent Application Publication
(10) Pub. No.: US 2021/0222098 A1
(43) Pub. Date: Jul. 22, 2021

(54) Process for Preparing a Cereal-Based Beverage with Malt and Malt Rootlets

(71) Applicant: Anheuser-Busch InBev S.A., Brussels (BE)

(72) Inventors: Paolo Bazzoli, Leuven (BE); Gabriel Gomes Da Silva, Leuven (BE)

(21) Appl. No.: 17/251,491

(22) PCT Filed: Jun. 14, 2019
(86) PCT No.: PCT/EP2019/065685

§ 371 Date: Dec. 11, 2020

(30) Foreign Application Priority Data
Jun. 14, 2018 (BE) BE2018/5398

(51) Int. Cl. C12C 11/00; C12C 7/01; C12C 7/047; C12C 7/165

(52) U.S. Cl. CPC C12C 11/003; C12C 7/165; C12C 7/047; C12C 7/01

(57) ABSTRACT

A process for preparing a cereal-based beverage, the method comprising: —providing malt or unmalted cereal grains; ˜mashing said malt or unmalted cereal grains to solubalize fermentable sugars therein the mashing comprising: —a first step wherein the malt or unmalted cereal grains are exposed to protease activity and optionally glucanase activity, the first step being carried out in a temperature interval A; —a subsequent second step wherein the malt or unmalted cereal grains are exposed to beta-amylase and alfa-amylase activity carried out in a temperature interval inhibiting the protease activity of the first step; —filtering the mashed malt or unmalted cereal grains to obtain a wort; —fermenting said wort to obtain the malt-based beverage; wherein the process comprises the addition of malt rootlets to the wort, characterised in that said malt rootlets are added to the malt or unmalted cereal grains during the second step of the mashing process at which protease activity is inhibited.

### FIELD OF THE INVENTION

The present invention concerns a process for preparing a cereal-based beverage with malt and malt rootlets as starting materials.

### BACKGROUND TO THE INVENTION

As malt-based beverages, beer, whisky, low-alcohol fermented beverages, non-alcohol beverages, and the like are known. Among these beverages, beer, and whisky are produced from wort derived from malt. Wort is produced from milled malt by a milling machine and converting the milled malt, optionally supplemented with a material other than malt such as corn into sugars (saccharification) in a mash kettle or in a mash tun. After saccharification, the wort is filtered, added with hops in the case of producing beer and boiled in a brew kettle. Then the mash is made to precipitate in a whirlpool, and cooled cold wort is subjected to fermentation. In production of whisky, the filtered wort is fermented with yeast and then subjected to distillation and maturation.

For example, in producing beer, which is one kind of malt-based beverage, it is possible to produce a variety of malt-based beverages with different flavor, foam quality, flavor stability, and haze stability, by selecting different kinds of starting malt and materials other than malt or varying the mash condition in production of wort, yeast species for use, fermentation condition and the like. To present, malt-based beverages having various flavors have been provided.

Although quality of malt which is a starting material is determined by the cultivar and quality of barley and by the malting condition, the effect of changing the flavor presented by malt itself is limited because malt which is a starting material is generally milled by a milling machine and the resultant malt is directly saccharified or supplemented with a material other than malt such as corn before saccharification. In the current state of art, production of various malt-based beverages having different flavors relies on selections of materials other than malt. In order to change the flavor of a malt-based beverage further or improve the foam quality, flavor stability, and haze stability, it is necessary to control the malt ingredient which is a starting material more specifically (cf. U.S. Pat. No. 9,499,777). DE3927315 describes a method of brewing beer comprising a two-step mashing step wherein the first step allows proteolytic activity and the second step inhibits proteases. DE '315 further discloses that (natural) foam stabilizers may be added during the process.

U.S. Pat. No. 3,039,879 describes a process for the manufacturing of malt beverages. Hydrogen peroxide and a peroxidase are added to the wort to enhance the foam stability. Said effect is obtained via the oxidation of certain organic compounds by hydrogen peroxide. The peroxidase acts as a catalyst but is not the crucial actor in the observed effect on foam stabilization.

Although it appears that malt rootlets have some interesting features in the production of fermented beverages, trials made to date did not allow for the production of market acceptable beverages with malt rootlets as an important ingredient and with beneficial effects believed obtainable from the use of malt rootlets such as increased beverage body appreciation and increased foam stability.

Indeed, in currently known beverage production processes including malt rootlets as starting material, sensitivity of the final product to oxidation has been considered an important drawback.

It is clear therefore that there remains a market and business need for fermented beverages prepared from malt rootlets as starting material.

### SUMMARY OF THE INVENTION

The present invention addresses the above problem by providing a process for preparing a cereal based fermented beverage, the process comprising:
providing malt or unmalted cereal grains;
mashing said malt or unmalted cereal grains to solubilize fermentable sugars therein the mashing comprising:
   a first step wherein the malt or unmalted cereal grains are exposed to protease activity and optionally glucanase activity, the first step being carried out in a temperature interval A;
   a subsequent second step wherein the malt or unmalted cereal grains are exposed to beta-amylase and alfa-amylase activity carried out in a temperature interval inhibiting the protease activity of the first step;
filtering the mashed malt or unmalted cereal grains to obtain a wort;
fermenting said wort to obtain the malt-based beverage;
   wherein the process comprises the addition of malt rootlets to the wort, characterised in that said malt rootlets are added to the malt or unmalted cereal grains during the second step of the mashing process at which protease activity is inhibited.

Or by a process comprising:
providing malt or unmalted cereal grains;
mashing said malt or unmalted cereal grains to obtain a solution of fermentable sugars;
providing malt rootlets;
preparing a solution of solubilized proteinaceous material by soaking the malt rootlets in a liquid at a temperature of between 62° C. and 90° C., allowing infusion of the liquid by the malt rootlets;
combining the solution of fermentable sugars and solubilised proteinaceous material to obtain a wort, wherein the combining may be performed by addition of the malt rootlets during mashing of the malt or unmalted cereal grains or by mashing the malt or unmalted cereal grains separately from the malt rootlets and combining the solution of fermentable sugars and solubilised proteinaceous material subsequently;
fermenting said wort to obtain the malt based beverage.

### BRIEF DESCRIPTION OF THE FIGURES

FIG. 1 shows the foam stability of a beer brewed by a process according to the present invention in view of a control beer;

FIG. 2 shows the foam quality of a control beer and of a beer brewed by a process according to the present invention.

FIG. 3 shows the results of an electrophoresis to determine the presence of proteinaceous material with a weight in a range of 10-40 kDa in a control beer and in a beer brewed by a process according to the present invention.

### DEFINITIONS

“Inhibited protease activity” is defined as a condition during a phase of the mashing process wherein protease activity is lower than 10% of the maximum protease activity obtained during a mashing phase wherein protease activity is desired and conditions are optimised for such activity.

### DESCRIPTION

The present invention concerns a process for preparing a cereal-based beverage, starting from malt or potentially an unmalted cereal grain and malt rootlets. Both the malt and malt rootlets are hereby considered as separate starting materials to produce the beverage and are handled separately.

The malt rootlets are part of dry germinated barley which is composed histologically of a husk portion, an endothelial layer portion, an endosperm portion, an acrospire portion, and a malt rootlets portion, and contents of components such as starch, protein, enzyme, and the like are known to differ among these tissue portions. Therefore, malt-based beverages of various different flavors can be obtained by fractionating these tissue portions, examining respective characteristics of the fractionated tissue portions, and blending and using the materials in combination as a starting material.

Malt rootlets are typically contained in dry germinated barley in an amount of about 2 to 3% by weight. The contents of protein component and amino acid are high. The contents of starch and polyphenol are relatively low. Malt rootlets may be used in an amount ranging from 30 g to 500 g/hL of beverage to be brewed calculated on a OG of 12° P, preferably between 50 g and 180 g/hL.

The malt rootlets are obtained from dry germinated barley that was produced by soaking barley in water to make it germinate, and drying, malt rootlets were separated from malt by means of a deculmer after kilning of the malt or can be collected from a bottom of kiln after kilning of the malt. The malt rootlets are collected and can be used as such or can be subsequently milled prior to use. In an embodiment, the malt rootlets are collected from a false bottom of the kiln after completing the kilning phase.

Regular deculmed and (partially) dehusked malt is milled as a second starting material. The milled malt is subsequently mashed either by an infusion mashing process or a decoction mashing process, wherein the malt is wetted and subjected to several enzymatic treatments at varying temperatures to finally obtain a solution of fermentable sugars. The mashing typically comprises a first step wherein the malt or unmalted cereal grains are exposed to proteolytic activity and optionally beta-glucanase activity, the first step being carried out in a temperature interval A (typically between 40 and 55° C.). Subsequently, the temperature of the mash is increased to temperatures between 62 and 72° C. at which the enzymes having proteolytic activity are inhibited and alfa- and beta-amylases operate at optimal or near optimal activity to break down starch into fermentable sugars.

In accordance with the present invention, it has been observed that in case the malt rootlets are added to the first step of the malt mashing process, relatively high concentrations of amino acids and fatty acids were obtained in the final beverage, that as a consequence was prone to oxidation reactions and showed low foam stability characteristics in comparison to beer prepared from regular malt without the addition of malt rootlets.

When adding the malt rootlets only to the second step of the malt mashing process however, the fatty acid content of the final beer is observed to be lower than when adding the malt rootlets earlier to the mashing process. Without being bound to any theory, it is believed that the late addition of the malt rootlets partially prevented degradation of the fatty acids and resulted in the fatty acids being filtered out of the mash (due to complex formation), such removal of the fatty acids apparently does not occur when the fatty acids are degraded beyond a certain level. Still, the addition of the malt rootlets to the mash after inhibition of protease activity resulted in a final beverage having desirable organoleptic properties (body) and good, if not better foam stability properties than beer brewed with only regular malt even without the use of known foam stability improving agents such as tetra hops to the malt rootlets based beer. The foam stability is believed to be improved by an increase in protein content and especially in protein fractions of 10 to 40 kDa in the brewed beverage observed with a process according to the present invention.

In an embodiment, no hydrogen peroxide is added during the brewing.

During several tests, a foam stability of over 200 seconds foam half life time (Nibem test) was found to be achievable.

In another or further embodiment, an increase in FAN (free amino acids) was observed in beer obtained by the above mentioned method. Free Amino Nitrogen (Fan) is defined as the sum of the individual amino acids, ammonium ions, and small peptides (di- and tripeptides) in wort. FAN is an important general measure of these nutrients, which constitute the nitrogen that yeast can assimilate during brewery fermentation. In an embodiment, an increase of FAN of between 5 to 25%, preferably 5 to 15% is obtained in beer brewed by the addition of malt rootlets or extract of malt rootlets compared to conventionally brewed beer. This permits to compensate for some deficit of FAN while still keeping good performance in fermentation.

A same beneficial effect on the malt rootlets is expected when the malt rootlets are soaked in a liquid (such as water, a filtered mash or wort) to infuse the liquid with the malt rootlets in order to obtain an extract. This is preferably performed at elevated temperatures of 62° C. or more to avoid oxidation of fatty acids or lipids present in the malt rootlets and to facilitate transfer of proteinaceous material from the rootlets to the liquid. After infusion, the liquid is preferably filtered to remove the solids and coagulated proteins, after which the filtered liquid comprising solubilized proteinaceous material can be mixed with the malt mash or can be mixed with the malt mash and subsequently filtered to obtain a fermentable wort.

While the exact nature of the protein is to date unknown, the structure and/or size of the protein fraction is believed to aid in the foam stability of the resulting beer. The proteins aiding in the foam stability are not proteases such as for instance peroxidase, as the latter are denatured and inactivated due to the high temperatures used during the mashing process. It is known that the activity of barley peroxidases is inhibited at higher temperatures. Pliet et al., 2012 (Plant Signal. Behay.) reported that 50% of the barley peroxidase activity is inhibited at 52° C.

The current invention thus also relates to a rootlet extract, lysate or a purified protein fraction from rootlets, preferably from the bottom of the rootlet kiln that can be used for enhancing the foam stability of a beer. Said rootlet extract or lysate is enriched in a 10 to 40 kDa protein fraction.

The present invention equally relates to a beverage obtainable via the process as described above.

In an embodiment, said beverage has a foam half-life of 200 seconds or more (Nibem test). In a further embodiment, said beverage is a beer or beer-like beverage or a whisky or whisky-like beverage.

In another or further embodiment, said beverage comprises a 10 to 40 kDa protein fraction obtained from malt rootlets. In an embodiment, said protein fraction in said beverage is present in between 0.01 and 0.5%. In an embodiment, said beverage does not comprise hydrogen peroxidase.

The invention equally relates to a method of increasing FAN by adding malt rootlets to the brewing process as described above. In an embodiment, the current invention is equally directed to a beverage such as a beer with an increased FAN level, said FAN level is increased between 5 to 25%, preferably 5 to 15%, compared to a control beer not brewed by addition of malt rootlets or malt rootlet extract.

### EXAMPLES

### Example 1

In a first example, three batches of beer were brewed starting from a same malt. For all batches the malt was mashed in a traditional cycle, starting with a first mashing step at 52° C., allowing proteases and beta-glucanases to solubilize the starch in the malt and break down proteins. Following step 1, the temperature of the mash is increased to 62° C. wherein the proteases and glucanases are inhibited. Once the temperature of the mash is at 62° C., milled or non-milled malt rootlets (110 g/hL for an OG of 14.5° P or 91 g/hL of final beer with an OG of 12° P) are added to one of the three batches and mashing is continued in a same manner for all three batches.

At the end of the mashing, the mashes are filtered and subsequently boiled to obtain three batches of wort adjusted to 14.5° P. All batches were inoculated and fermented with a Saccharomyces pastorianus to full attenuation, followed by a maturation cycle. The batch containing the malt rootlets and one control batch were filled into bottles, whereas to a third batch tetra hops were added as a commonly known foam stability agent prior to filling in a bottle.

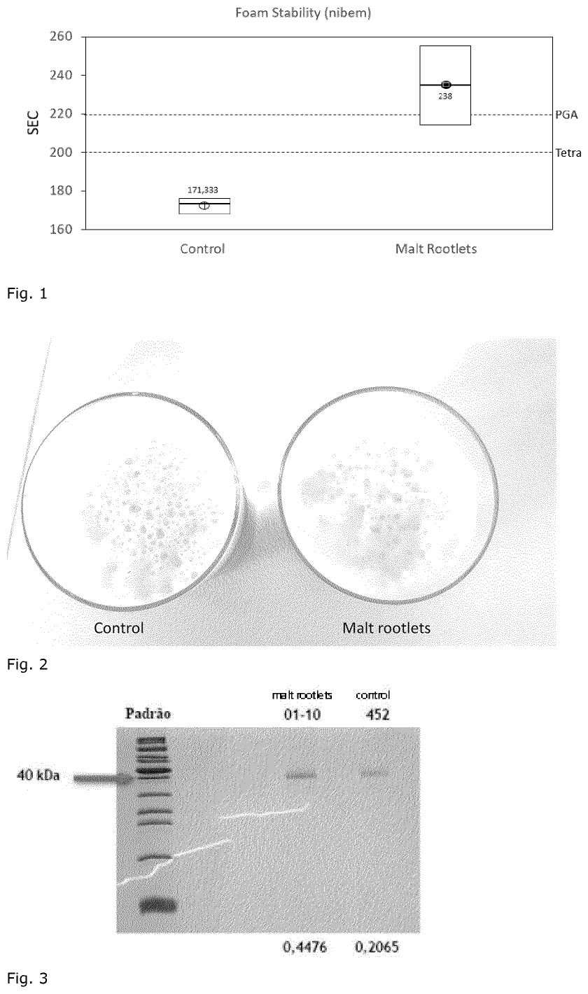

The beer from all three batches was subsequently dispensed in a glass and foam stability was measured. As can be deducted from FIG. 1, foam stability was superior in the batch comprising malt rootlets over the control batch and the batch prepared with tetra hops. Indeed, a foam stability of about 238 seconds half-life time (time elapsing before the foam collapses to half of its original height) was measured for the beer brewed with the addition of malt rootlets. Apart from improved foam stability, visual control of the foam (FIG. 2) showed that the foam quality of the batch prepared with malt rootlets was superior in terms of smoothness and silkiness.

As the foam stability is believed to be correlated to the content of proteinaceous material of between 10-40 kDa, an electrophoresis was carried out on the final beer of the control and the beer brewed with addition of malt rootlets (FIG. 3). FIG. 3 shows an SDS protein gel loaded with a beer brewed by addition of a rootlets and one without addition of said rootlets or stabiliser (control). A strong protein band is visible at around 40 kDa with smaller bands below (less visible). As can be seen, the beer with malt rootlets indeed has a higher content of 40 kDA proteinaceous material, compared to the control. This proteinaceous material is not peroxidase as the activity of the latter is inhibit due to the high temperature used in the mashing process. It is believed that the structure and/or size of the protein or protein fraction aids in the stabilisation of the foam stability.

In addition to a better foam stability, an increase of FAN of 15% was observed in the batch comprising malt rootlets over the control batch and the batch prepared with tetra hops (150 mg/L for the control whereas 175 mg/L for the rootlets batch).

1. A process for preparing a cereal-based beverage, the method comprising:
providing malt or unmalted cereal grains;
mashing said malt or unmalted cereal grains to solubalize fermentable sugars therein the mashing comprising:
a first step wherein the malt or unmalted cereal grains are exposed to protease activity and optionally glucanase activity, the first step being carried out in a temperature interval A;
a subsequent second step wherein the malt or unmalted cereal grains are exposed to beta-amylase and alfa-amylase activity carried out in a temperature interval inhibiting the protease activity of the first step;
filtering the mashed malt or unmalted cereal grains to obtain a wort;
fermenting said wort to obtain the malt-based beverage;
wherein the process comprises the addition of malt rootlets to the wort, characterised in that said malt rootlets are added to the malt or unmalted cereal grains during the second step of the mashing process at which protease activity is inhibited.

2. A process for preparing a cereal-based beverage, the method comprising:
providing malt or unmalted cereal grains;
mashing said malt or unmalted cereal grains to obtain a solution of fermentable sugars;
providing malt rootlets;
preparing a solution of solubilized proteinaceous material by soaking the malt rootlets in a liquid at a temperature of between 62° C. and 90° C., allowing infusion of the liquid by the malt rootlets;
combining the solution of fermentable sugars and solubilised proteinaceous material to obtain a wort,
fermenting said wort to obtain the malt based beverage.

3. The process according to claim 1, comprising filtering the mash and/or the solubilised proteinaceous material.

4. The process according to claim 1, wherein the liquid in which the malt rootlets are soaked are either unfiltered mash, water or wort.

5. The process according to claim 1, comprising separating the malt rootlets from the malt after kilning of the malt.

6. The process according to claim 1, lacking the addition of tetra hops and or polypropylene glycol alginate during or post preparation of the beverage.

7. The process according to claim 1, comprising using malt rootlets in an amount ranging from 30 g to 500 g/hL of beverage to be brewed calculated on a OG of 12° P.

8. The process according to claim 1, comprising using malt rootlets in an amount ranging from 50 g to 180 g/hL of beverage to be brewed calculated on a OG of 12° P.

9. The beverage obtainable by a process according to claim 1.

10. The beverage according to claim 9, having a foam half-life of 200 seconds or more (Nibem test).

11. The beverage according to claim 9, being a beer or beer-like beverage or a whisky or whisky-like beverage.

12. The beverage according to claim 9, wherein said beverage comprises a 10 to 40 kDa protein fraction obtained from malt rootlets.

13. Use of a malt rootlet extract or lysate for enhancing the foam stability of a beer.

14. The use according to claim 13, wherein said malt rootlet extract or lysate is enriched in a 10 to 40 kDa protein fraction.

15. Method for brewing beer, said method comprises a mashing step, characterized in that during said mashing malt rootlets are added to the malt or unmalted cereal grains.

16. The method according to claim 15, wherein said mashing step is a two-step process and said malt rootlets are added during a second step of the mashing process at which protease activity is inhibited.

17. The process according to claim 2, wherein the liquid in which the malt rootlets are soaked are either unfiltered mash, water or wort.

18. The process according to claim 2, comprising using malt rootlets in an amount ranging from 30 g to 500 g/hL of beverage to be brewed calculated on a OG of 12° P.

19. The process according to claim 2, comprising using malt rootlets in an amount ranging from 50 g to 180 g/hL of beverage to be brewed calculated on a OG of 12° P.

20. The beverage obtainable by a process according to claim 2.
